(19) United States
(12) Patent Application Publication
(10) Pub. No.: US 2013/0269250 A1
(43) Pub. Date: Oct. 17, 2013

(54) NESTING PLANTER

(71) Applicant: AMES TRUE TEMPER, INC., Camp Hill, PA (US)

(72) Inventor: CHUN WAI HUNG, DILLSBURG, PA (US)

(73) Assignee: AMES TRUE TEMPER, INC., Camp Hill, PA (US)

(21) Appl. No.: 13/729,071

(22) Filed: Dec. 28, 2012

Related U.S. Application Data
(63) Continuation-in-part of application No. 29/418,200, filed on Apr. 13, 2012.

(51) Int. Cl. A01G 9/02

(52) U.S. Cl. CPC A01G 9/02
USPC 47/65.5

(57) ABSTRACT

Nested planters are provided. The nested planters include a body having a base assembly and a depending sidewall, the body defining a substantially enclosed space. The base assembly includes a generally horizontal planar member and a stand-off feature. The stand-off feature is structured to extend downwardly from the planar member. A substantial portion of the body sidewall is structured to correspond to the body sidewall of another nesting planter when two nesting planters are nested.

### CROSS REFERENCE TO RELATED APPLICATION

This application is a continuation-in-part of U.S. Design application Ser. No. 29/418,200, entitled “SELF-WATERING PLANTER,” which was filed on Apr. 13, 2012.

### FIELD OF THE INVENTION

The present invention relates to planters and, more specifically, to planters sized and shaped to nest in an efficient manner.

### BACKGROUND OF THE INVENTION

Hollow tapered objects may be nested. That is, one hollow tapered object may be positioned inside a similar object whereby the two objects occupy slightly more space than a single object. The two objects will have the same cross-section area as a single object, but the stack of objects will be slightly elongated relative to a single object. Moreover, multiple hollow tapered objects may be stored in a similar manner. Thus, having a hollow tapered shape allows for the storage and shipment of multiple objects in a reduced space relative to non-tapered objects. For example, paper cups, hats, bowls, trash cans, wheelbarrow trays, and buckets may all be nested.

There are at least two problems associated with the stacking of tapered objects. First, the objects may become stuck together. That is, the shape of the tapered objects may allow a substantial portion of the sidewalls to engage each other. Such engagement creates friction when a user attempts to separate the objects. If the starting friction is too great, the user may not be able to separate the objects. This problem is typically associated with objects wherein the taper is not great. A second problem is that, if the objects have solid sidewalls, i.e. no openings, a partial vacuum may form when the objects are stacked. That is, when one object is inserted into another, the air in the lower object is forced out of the hollow space. If the sidewalls of the two objects connect, it may be difficult to separate the objects as air cannot pass by the sidewalls to refill the hollow space during separation. Thus, in the gap between the two objects a partial vacuum, or low pressure space, is formed.

Further, the number of objects that may be stacked in a selected space, i.e. a selected vertical height, is also effected by dimensions and configuration of the tapered objects. For example, objects with a minimal taper and thick sidewalls will not be able to be positioned deeply within each other. That is, the sidewall of the upper object will contact the sidewall of the lower object when the upper object is only partially disposed within the lower object. Moreover, in this configuration, the contact between the stacked object may allow one object to damage another object, especially the highly visible side and top areas.

Thus, there is a need for a tapered object having an improved shape that allows for more efficient stacking.

There is a further need for a tapered object configured so that, when stacked, the objects have minimal contact with each other.

### SUMMARY OF THE INVENTION

The disclosed and claimed concept relates to nested planters. That is, nested planters are tapered objects. The nested planters include a body having a base assembly and a depending sidewall, the body defining a substantially enclosed space. The base assembly includes a generally horizontal planar member and a stand-off feature. The stand-off feature is structured to extend downwardly from the planar member. Thus, a substantial portion of the body sidewall is structured to substantially correspond to the body sidewall of another nesting planter when two nesting planters are nested. In this configuration, the body sidewalls do not contact each other. Thus, there is minimal damage to the sidewalls during shipping and storage. Further, as there is a gap between the sidewalls, no partial vacuum may form during separation of the objects. It is noted that the stand-off feature ensures that the tapered sidewalls do not move into a position wherein the sidewalls contact each other. That is, the stand-off feature ensures that the sidewalls are maintained in a corresponding relationship rather than a snuggly corresponding relationship.

The lack of contact between the stacked nested planters results from the shape of the nested planter's body. That is, configuration or shape of the nested planters or individual features of the nested planters, i.e. the thickness of the sidewall, the degree of taper of the sidewall, and the height of the stand-off feature solve the problems set forth above.

### BRIEF DESCRIPTION OF THE DRAWINGS

A full understanding of the invention can be gained from the following description of the preferred embodiments when read in conjunction with the accompanying drawings in which:

FIG. 1 is an isometric view of a single nesting planter.

FIG. 2 is a side view of two nesting planters.

FIG. 3 is a cross-sectional view of two nesting planters.

FIG. 4 is a detail view of the two nesting planters of FIG. 3.

FIG. 5 is an isometric view of another embodiment of a single nesting planter.

FIG. 6 is a side view of another embodiment of two nesting planters.

FIG. 7 is a cross-sectional view of another embodiment of two nesting planters.

FIG. 8 is a detail view of the two nesting planters of FIG. 7.

FIG. 9 is an isometric view of another embodiment of a single nesting planter.

FIG. 10 is a side view of another embodiment of two nesting planters.

FIG. 11 is a cross-sectional view of another embodiment of two nesting planters.

FIG. 12 is a detail view of the two nesting planters of FIG. 11.

FIG. 13 is an isometric view of another embodiment of a single nesting planter.

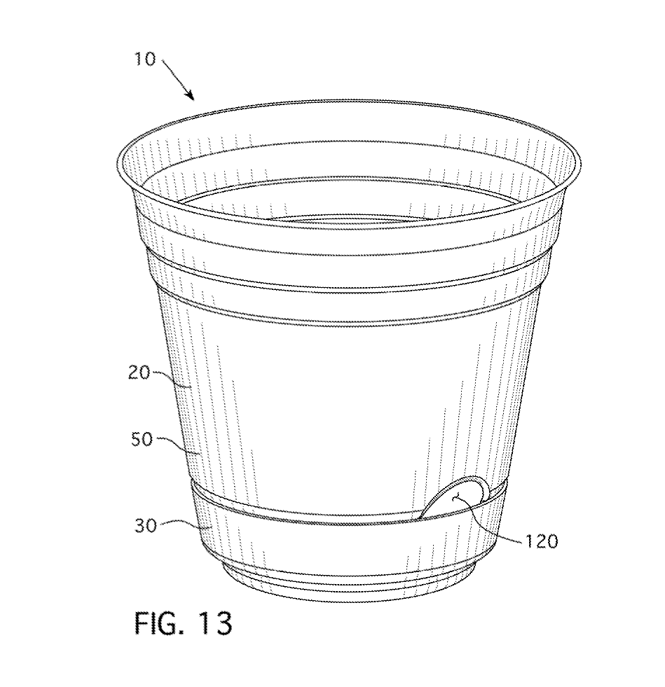

### DESCRIPTION OF THE PREFERRED EMBODIMENTS

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other. The fixed components may, or may not, be directly coupled.

As used herein, “engage” means to contact with bias. The bias may be created by the weight on a component. That is, if one component is disposed on top of another component, and not suspended, the upper component “engages” the lower component in that the weight of the upper component creates a bias on the lower component.

As used herein, the word “unitary” means a component is created as a single piece or unit. That is, a component that includes pieces that are created separately and then coupled together as a unit is not a “unitary” component or body.

As used herein, “temporarily coupled” means that two components are coupled in a manner that allows for the components to be easily decoupled without damaging the components.

As used herein, “correspond” indicates that two structural components have a similar cross-sectional shape and are sized so that one component may be inserted in the other component. That is, there is a small gap between the components. Thus, an opening which “corresponds” to a member is sized slightly larger than the member so that the member may pass through the opening. A “small gap,” as used herein is proportional to the size of the planter and the thickness of the planter body. Generally, a “small gap” is about the same size as the thickness of the planter body if the planter body is made from plastic. It is understood that during the act of inserting a component into a “corresponding” component, the two components may touch; however, a first component that “corresponds” to a second component may be positioned within the second component without contact. It is further understood that to be “positioned within the other component without contact,” the first component may be supported.

Further, as used herein, “narrowly correspond” means that the gap between the two components is between about 0.01 and 0.1 inch and may be about 0.02 inch.

Further, as used herein, “snugly correspond” means that one or more points of the two components are in contact. That is, one “snugly corresponding” component fits within the other component, but the components contact each other.

As used herein, “nesting” or “nested” means that two hollow bodies having a similar shape are disposed with one body substantially inside the other body. Thus, a planter disposed in a basin, wherein the basin is substantially more shallow than the planter, is not “nested” as the planter is not disposed substantially inside the basin.

As used herein, “nesting planters” means a set of planters having a substantially similar shape. It is understood that different sets of nesting planters may have different shapes. Thus, there may be a set of circular nesting planters and a set of rectangular nesting planters. It is understood that when nesting planters are described as nesting in each other, disposed in each other, etc, it means that the nesting planters are from one set, i.e. the nesting planters have a substantially similar shape.

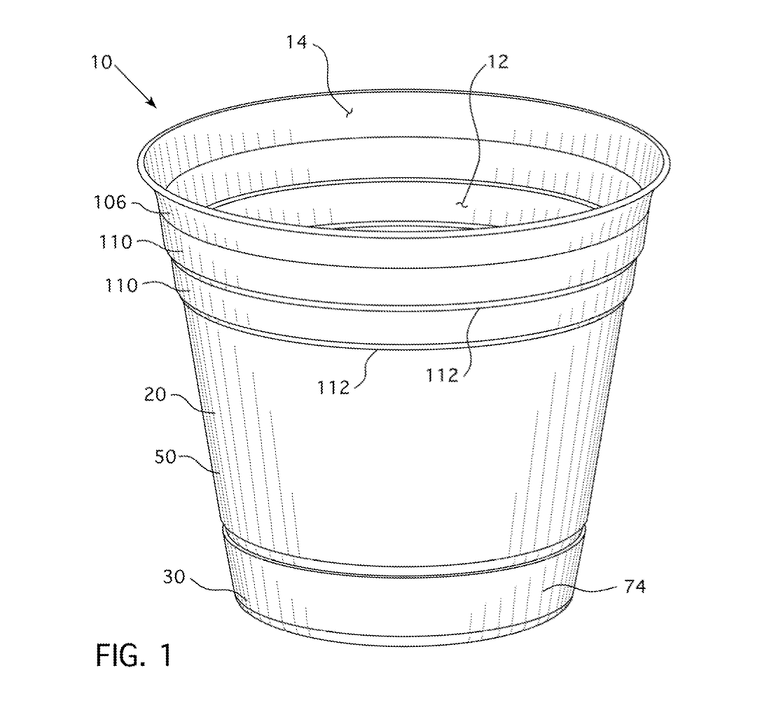

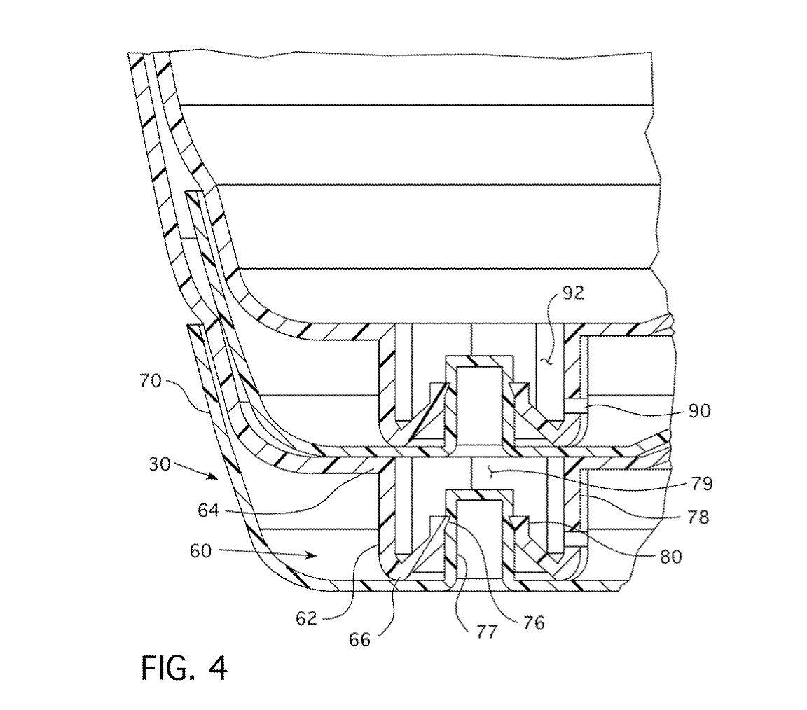

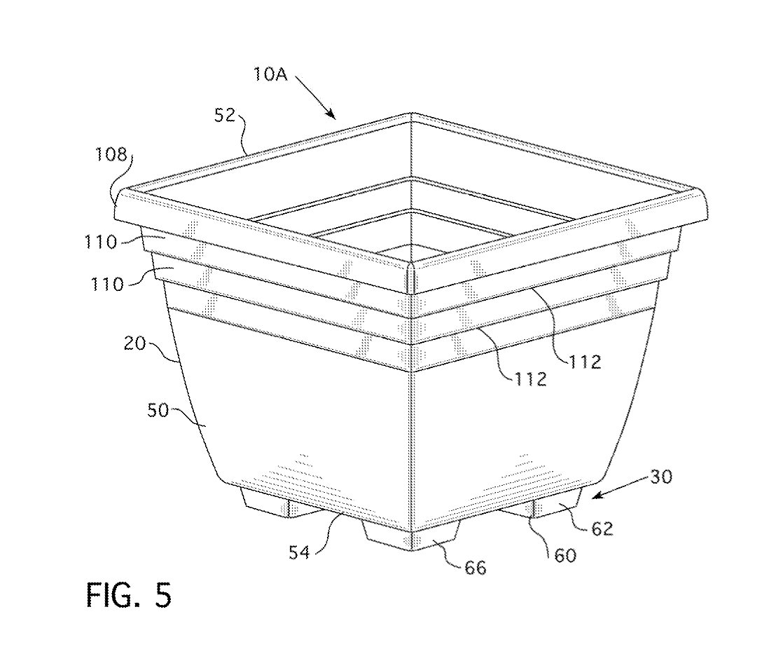

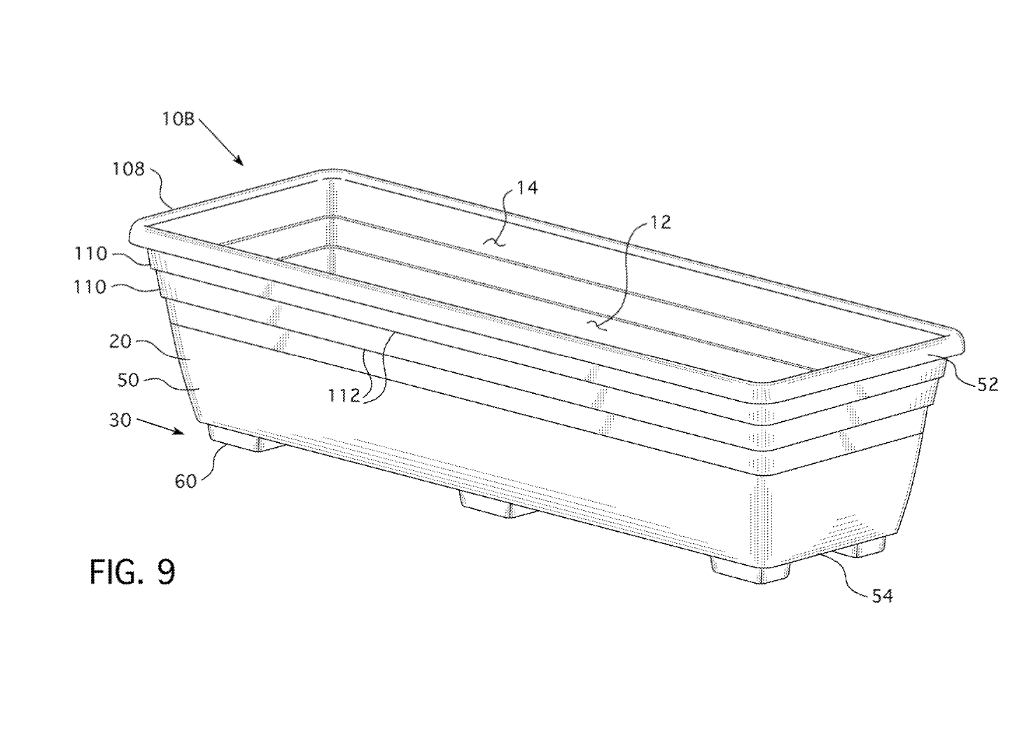

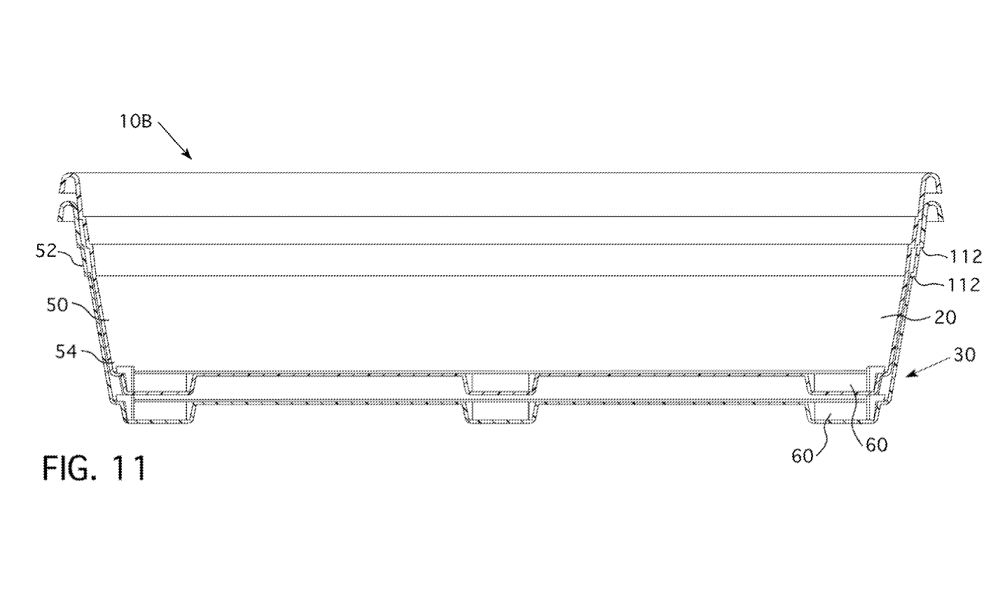

As shown in FIGS. 1-12, a nesting planter 10 (FIGS. 1-4), 10A (FIGS. 5-8), 10B (FIGS. 9-12) includes a body 20, 20A, 20B defining a substantially enclosed space 12. As used herein, a “substantially enclosed space” includes a cup-like shape having an open end or side. Nesting planter body 20, 20A, 20B may have any cross-sectional shape, e.g. a circular body 20 (FIGS. 1-4), a square body 20A (FIGS. 5-8), and a rectangular body 20B (FIGS. 9-12). Further, the body may have more complex cross-sectional shapes such as, but not limited to rounded squares, hexagonal, or asymmetrical shapes, e.g. star shaped. The nesting planter 10, 10A, 10B may also have different dimensions. For example, as used herein, a “small size” nesting planter 10, 10A, 10B has a width of between about four inches to about six inches, a “mid size” nesting planter 10, 10A, 10B has a width of between about ten inches to about sixteen inches, and a “large size” nesting planter 10, 10A, 10B has a width of between about twenty inches to about twenty-four inches.

The following discussion will refer to the embodiment shown in FIG. 1, the circular body 20, but it is understood that the discussion is applicable to all embodiments.

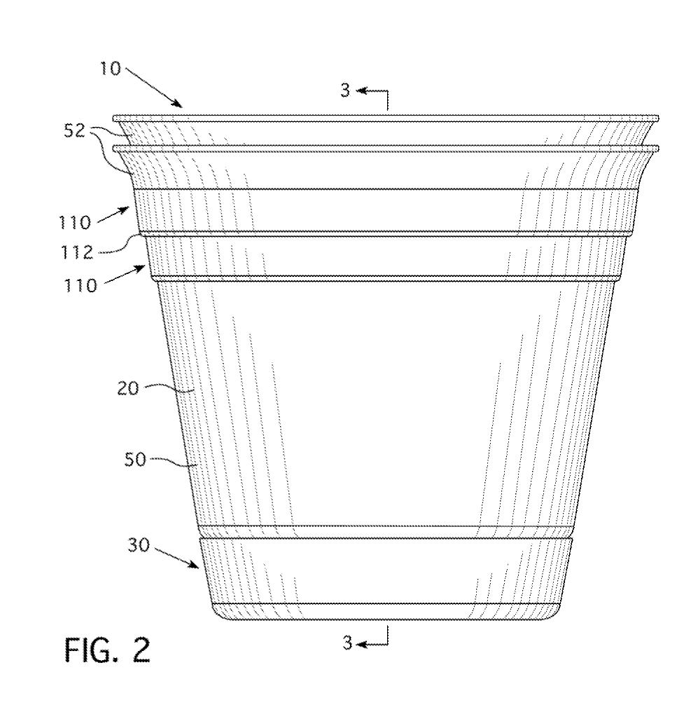

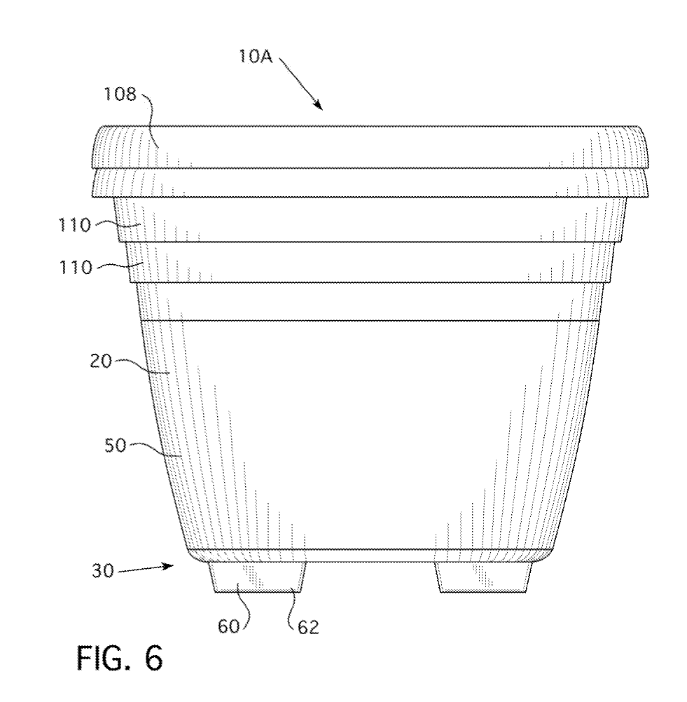

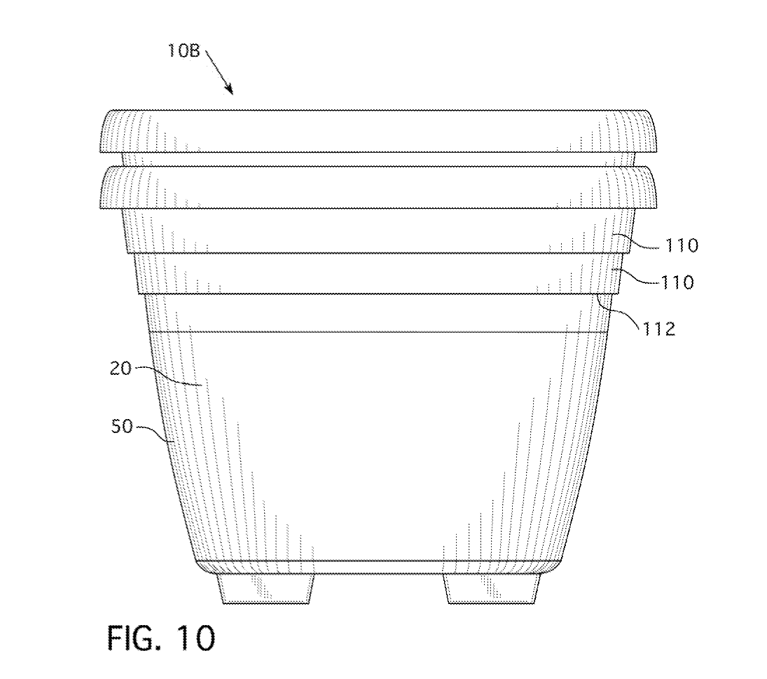

It is further not that selected figures disclose two nested nesting planters 10 (FIGS. 2-4), 10A (FIGS. 6-8), 10B (FIGS. 10-12), in these figures the reference numbers are, generally, only applied to one nesting planter 10, 10A, 10B for clarity. It is understood, however, that both nesting planters 10, 10A, 10B have substantially similar elements.

As shown in FIGS. 2-4, the nesting planter body 20 includes a base assembly 30 and a depending sidewall 50. The base assembly 30 includes a generally planar member 32. The base assembly generally planar member 32 may be concave, convex, or may include surface features such as, but not limited to grooves and openings. For example, in the embodiment shown in FIG. 1, a center portion 34 of the base assembly planar member 32 is elevated relative to a peripheral portion 36 of the base assembly planar member 32. Thus, the peripheral portion 36 is a channel 37 relative to the center portion 34. It is understood that base assembly 30 is the bottom of the nesting planter body 20 and is structured to support substances for growing plants, e.g. dirt. Thus, the planar member 32 extends generally horizontally and has a central vertical axis 38 extending normal to the plane of the planar member 32. In one embodiment, nesting planter body 20 is imperforated. That is, there are no openings or passages through the nesting planter body 20. The lack of openings through the nesting planter body 20 does not include a lack of a large opening 14 allowing access to the substantially enclosed space 12. In another embodiment, discussed below, the nesting planter body 20 includes passages 92, discussed below. It is further noted that is a protective layer, such as but not limited to tissue paper (not shown), may be used to protect the nesting planter 10 during transport and storage. If such a protective layer is disposed on the upper surface of the planar member 32, it is, as used herein, part of the planar member 32.

Body sidewall 50 extends upwardly from the periphery of the base assembly 30. In one embodiment, body sidewall 50 is unitary with base assembly 30. Body sidewall 50 has an upper end 52 and a lower end 54. Depending sidewall lower end 54 is coupled to, and in one embodiment directly coupled to and/or unitary with, base assembly 30. Nesting planter body 20 is tapered from the depending sidewall upper end 52 to the depending sidewall lower end 54. That is, depending sidewall lower end 54 has a smaller cross-sectional area than depending sidewall upper end 52.

Body sidewall 50 is, in one embodiment, generally straight when viewed in cross-section. That is, the tapered body sidewall 50 is substantially conical, with the exception of selected features as discussed below. In another embodiment, the body sidewall 50 is curved, and may be parabolic (not shown), in cross-section. Generally, in a small size nesting planter 10, 10A, 10B, the body sidewall 50 has a thickness of between about 0.03 and 0.05 inch, and may be about 0.04 inch thick. In a mid size nesting planter 10, 10A, 10B, the body sidewall 50 has a thickness of between about 0.05 and 0.07 inch, and may be about 0.06 inch thick. In a large size nesting planter 10, 10A, 10B, the body sidewall 50 has a thickness of between about 0.07 and 0.09 inch, and may be about 0.08 inch thick. In the embodiment where the body sidewall 50 is substantially conical, the body sidewall 50 has an angle relative to the planar member central vertical axis 38 of between about 7 and 11 degrees and may be about 9 degrees.

The base assembly 30 also includes a stand-off feature 60. The stand-off feature 60 is structured to extend downwardly from the planar member 32. In this configuration, the stand-off feature 60 is structured to be directly coupled to the upper surface of a planar member 32 of an adjacent, lower nesting planter 10 when the nesting planters 10 are nested. The stand-off feature 60 is further structured to maintain the nesting planters in a substantially spaced relationship when the nesting planters 10 are nested. That is, “substantially spaced,” as used herein, means that a greater part of the surface area of two adjacent nesting planters 10 are not in contact with each other. In one embodiment, only the lower surface of the upper nesting planter's 10 stand-off feature 60 is directly coupled to the upper surface of the lower nesting planter's 10 base assembly 30, and more specifically, the upper surface of the lower nesting planter's 10 planar member 32.

In one embodiment, the stand-off feature 60 includes at least one pedestal 62. The pedestals 62 have an upper end 64 and a lower end 66. As shown, in FIGS. 5-8, there are four pedestals 62 in the embodiment wherein the body 20 is circular. The pedestals 62 may be evenly spaced. Thus, in the embodiment with a circular body 20 the pedestals 62 may be about 90 degrees apart and disposed at about the same distance from the center of the circular body 20. In the embodiment shown in FIG. 5, there are four pedestals 62 (three shown) wherein the body 20A. In the embodiment with a square body 20A the pedestals 62 are disposed adjacent each corner of the square body 20A, i.e. about 90 degrees apart. As shown, in FIGS. 9-12, there six pedestals 62 in the embodiment wherein the body 20B is rectangular. In the embodiment with a rectangular body 20B the pedestals 62 are disposed adjacent each corner of the rectangular body 20B as well as at about the mid-point of the longitudinal sides. Each pedestal 62 may be unitary with the base assembly 30. The pedestals 62 have a height of between about 0.75 inch and 1.125 inch, and may be about 0.9 inch.

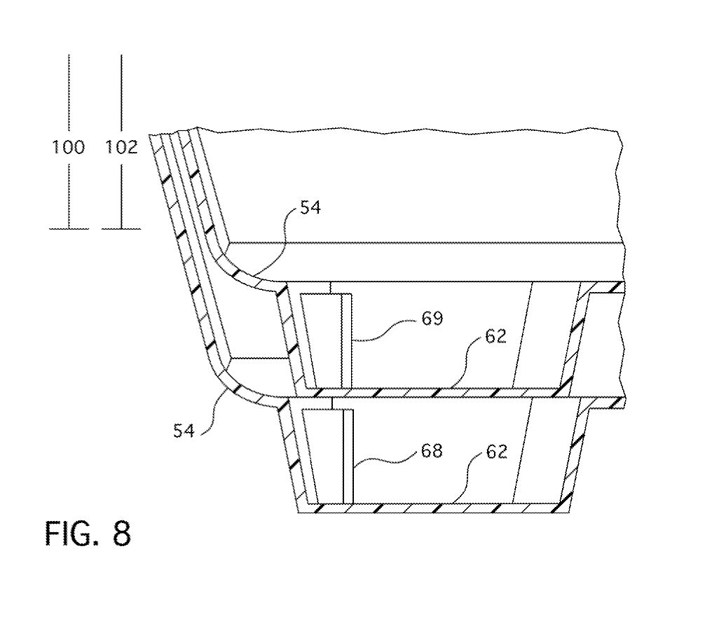

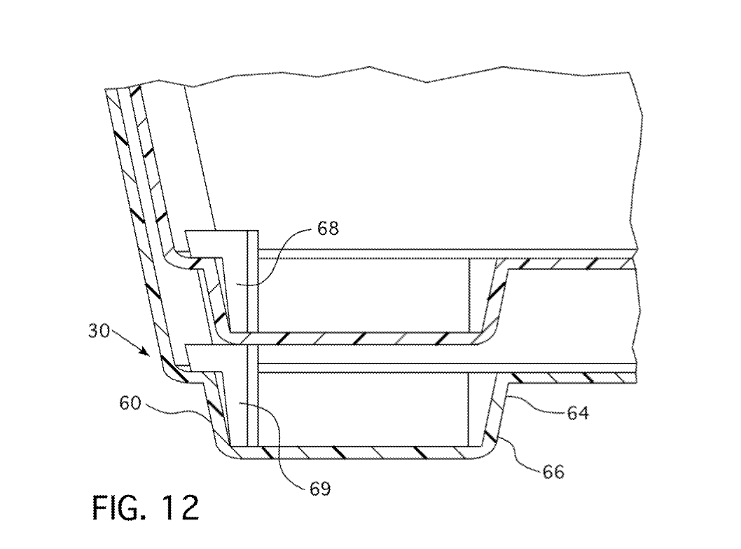

The pedestals 62 may be hollow and tapered. To prevent the pedestals 62 from nesting, the pedestals 62 include a blocking member 68. The blocking member 68 (FIGS. 8 and 12) ensures that the cross-sectional area of the inner side of a pedestal upper end 64 is smaller than the cross-sectional area of the outer side of a pedestal lower end 66. As shown, the blocking member 68 is an inwardly extending rib 69 extending adjacent the inner side of a pedestal upper end 64. The blocking member 68 may, however, be an inwardly extending flange disposed about the inner side of a pedestal upper end 64, multiple ribs, a central post, or any construct (none shown) that presents the pedestals 62 from an upper nesting planter 10 from nesting in the pedestals 62 of the lower nesting planter 10.

In one embodiment, shown in FIGS. 1-4, the stand-off feature 60 includes a basin 70. The basin 70 is a dish-like construct including a base member 72 and a depending sidewall 74. The basin base member 72 and basin sidewall 74 may be unitary. Basin base member 72 is generally planar and may include an upwardly extending coupling component 76, discussed below. The basin sidewall 74 is tapered from top to bottom. In one embodiment, the conical shape of the body sidewall 50 and the basin sidewall 74 are similar so that the basin sidewall 74 is substantially a continuation of the body sidewall 50. As shown, the basin base member coupling component 76 is a lug 77. In this embodiment, the pedestals 62 may include a coupling component 78 such as socket 79. The basin base member coupling component 76 and the pedestal coupling component 78 are structured to be coupled together. The basin base member coupling component 76 and the pedestal coupling component 78 may be held together by friction, i.e. the lug 77 may snuggly correspond to the socket 79. Alternatively, the basin base member coupling component 76 and the pedestal coupling component 78 may include a latch 80.

In this embodiment, the pedestals 62, and therefore the body 20, may include opening(s) 90. That is, in this embodiment, the pedestals 62 may be hollow and define a passage 92. An opening 90 may be disposed near the pedestal lower end 66. The combination of a hollow pedestal 62 with an opening 90 define the passage 92. In this configuration, there is a path for excess water to escape the enclosed space 12. That is, when in use, water may move downwardly to the base assembly 30, then through the pedestal passage 92 and into the basin 70. Further, in this embodiment, and in a small size nesting planter 10, 10A, 10B, basin 70 has a thickness of between about 0.03 inch and 0.04 inch, and may be about 0.035 inch. In a mid size nesting planter 10, 10A, 10B, basin 70 has a thickness of between about 0.04 inch and 0.06 inch, and may be about 0.05 inch. In a large size nesting planter 10, 10A, 10B, basin 70 has a thickness of between about 0.06 inch and 0.08 inch, and may be about 0.07 inch. Further, the basin base member 72 in a small size nesting planter 10, 10A, 10B has a thickness of between about 0.025 inch and 0.035 inch, and may be about 0.03 inch. The basin base member 72 in a mid size nesting planter 10, 10A, 10B has a thickness of between about 0.04 inch and 0.06 inch, and may be about 0.045 inch. The basin base member 72 in a large size nesting planter 10, 10A, 10B has a thickness of between about 0.07 inch and 0.08 inch, and may be about 0.065 inch.

Thus, in this embodiment, the pedestals 62 in a small size nesting planter 10, 10A, 10B have a height of between about 0.25 inch and 0.35 inch, and may be about 0.3 inch. The pedestals 62 in a mid size nesting planter 10, 10A, 10B have a height of between about 0.4 inch and 0.55 inch, and may be about 0.5 inch. The pedestals 62 in a large size nesting planter 10, 10A, 10B have a height of between about 0.55 inch and 0.7 inch, and may be about 0.6 inch. As such, the height of the stand-off feature 60 is the combined height of the pedestals 62 and the thickness of the basin 70, and more specifically the thickness of the basin base member 72.

The nesting planter 10, 10A, 10B is structured to be nested. That is, one nesting planter 10, 10A, 10B is structured to be substantially disposed within another. Moreover, multiple nesting planters 10, 10A, 10B may be nested. The following description, shall use two nesting planters 10, 10A, 10B as an example. The nesting planters 10, 10A, 10B have a substantially similar shape. The nesting planters 10, 10A, 10B will be described as the “upper” nesting planter 10, 10A, 10B and the “lower” nesting planter 10, 10A, 10B. It is understood that, because the nesting planters 10, 10A, 10B have a substantially similar shape, the positions of the upper and lower nesting planters 10, 10A, 10B may be reversed. It is further understood that additional nesting planters 10, 10A, 10B may be further nested in the upper nesting planter 10, 10A, 10B.

In the embodiments described above, the body sidewall 50 of the lower nesting planter 10, 10A, 10B corresponds to the body sidewall 50 of the upper nesting planter 10, 10A, 10B. In the embodiment without a basin 70, as shown in FIGS. 5-8 (a square body 10A), each pedestal 62 of the upper nesting planter 10A is directly coupled to the upper surface of the base assembly planar member 32 of the lower nesting planter 10A, and more specifically to blocking member 68. The pedestals 62 have a sufficient height to maintain the body sidewall 50 of the lower nesting planter 10A in a spaced relation to the body sidewall 50 of the upper nesting planter 10A. More specifically, a “substantial portion,” as defined below, of the two body sidewalls 50 correspond to each other and/or narrowly correspond to each other. That is, as used herein, a “substantial portion” of the body sidewall 50 that corresponds to the nested nesting planter body sidewall 50 is the medial portion of the body sidewall 50 and does not include the body sidewall lower end 54 and the base assembly 30. Further, a “substantial portion” of the body sidewall 50 means the portion that extends about a substantial portion of the body 20. That is, a body that minor portions, e.g. ribs or an upper rim, that are located adjacent another nesting body does not have a “substantial portion” of the body sidewall corresponding to the nested nesting body sidewall. Further, the “substantial portion” of the body sidewall 50 may not include the body sidewall upper end 52 if there is a shaped rim 100, discussed below.

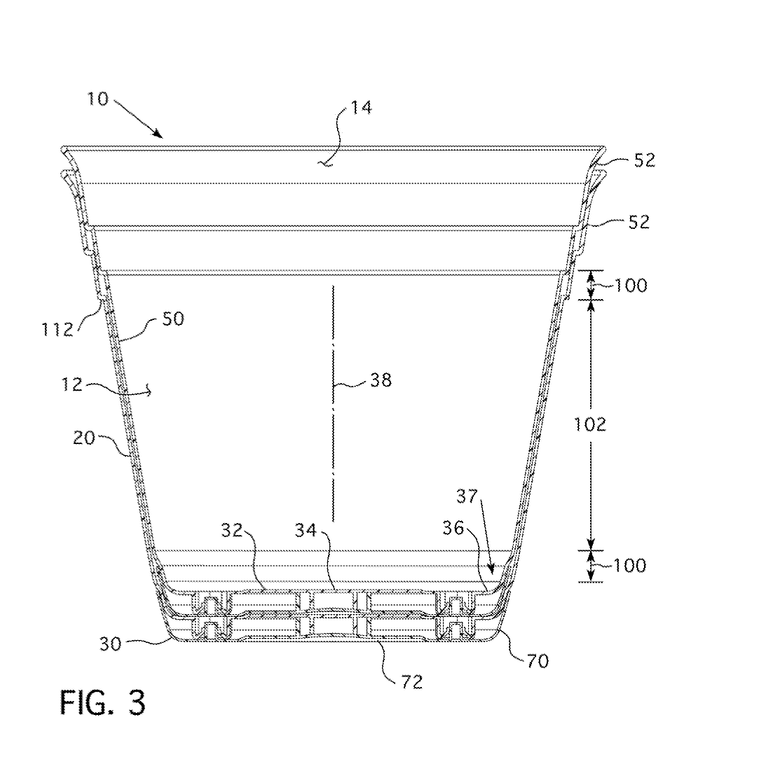

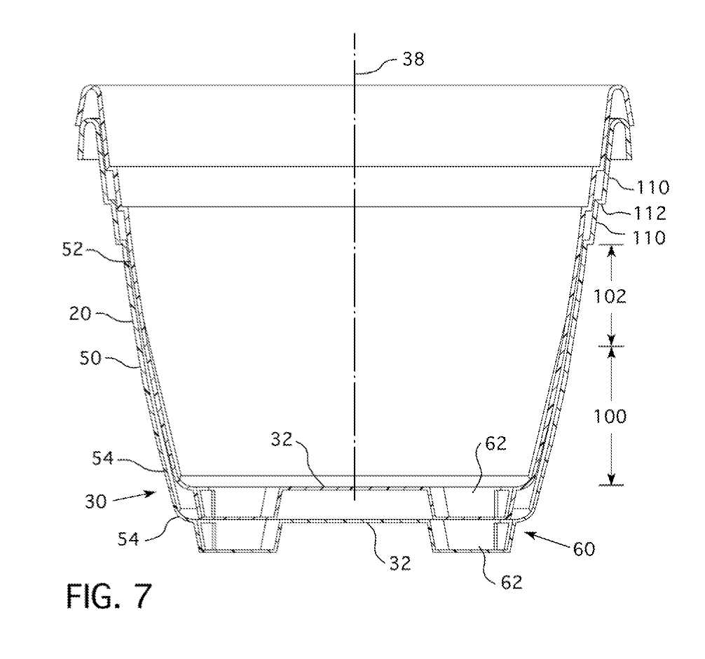

Accordingly, when the two body sidewalls 50 correspond to each other there is a small gap between the two body sidewalls 50. When the two body sidewalls 50 narrowly correspond to each other, there is a gap of about 0.01 and 0.1 inch, and may be 0.02 inch, between the two body sidewalls 50. The nesting planters 10, 10A, 10B may further be shaped so that said sidewall 50 includes a corresponding portion 100 and/or a narrowly corresponding portion 102 within the “substantial portion” of the two body sidewalls 50 that correspond to each other. Within the corresponding portion 100 there is a small gap between the two body sidewalls 50. Within the narrowly corresponding portion 102 the gap between the two body sidewalls 50 is between about 0.01 and 0.1 inch, and may be about 0.02 inch. As shown in FIG. 3, the narrowly corresponding portion 102 is disposed between to corresponding portions 100, that is the corresponding portions 100 are located adjacent the body sidewall upper end 52 and the body sidewall lower end 54. Alternatively, as shown in FIG. 7, a narrowly corresponding portion 102 is disposed above a corresponding portion 100. It is understood, however, that these are exemplary configurations and other configurations having a corresponding portion 100 and a narrowly corresponding portion 102 may exist.

As described below, selected elevations, i.e. elevations of the body 20 at a selected height above or below the base assembly 30, or selected areas, i.e. a localized area of the body sidewall 50, may include decorative or utilitarian features. Such selected areas may not correspond, or narrowly correspond, to the like area on the adjacent nesting planter 10A. As described above, a “substantial portion” of the body sidewall 50 is structured to correspond to the body sidewall 50 of another nesting planter 10, 10A, 10B when the other nesting planter 10, 10A, 10B is nested. For example, elevations adjacent the body sidewall lower end 54 curve into the base assembly 30. Thus, these elevations do not “correspond” to the nested body as that term is defined herein. It is understood that, due to the vertical offset of the nested planters 10 when nested, that the overlapping “substantial portion” of each nested planter 10 varies slightly depending upon the nested planter's 10 location. For example, the “substantial portion” of the upper nesting planter 10 will start at a lower elevation than the “substantial portion” of the lower nesting planter 10.

That is, the body sidewall upper end 52 may be a shaped rim 104 such as, but not limited to a flared upper end 106 or a rolled upper end 108. A flared upper end 106, shown in FIGS. 1-4, is angled outwardly at a greater angle than the taper identified above. Alternatively, a flared upper end 106 may be curved outwardly. A rolled upper end 108, shown in FIGS. 5-8, includes a arcuate portion extending over 90 degrees and typically closer to about 180 degrees. A rolled upper end 108 in cross-section is similar to a parabola.

Further, the sidewall upper end 52 may include features such as offset elevations 110. An offset elevation 110 is an elevation wherein the cross-sectional area increases at a discrete step. That is, there is an outwardly extending flange 112 in the body sidewall 52. When nesting planters 10 are nested, the offset elevation 110 may not correspond to the shape of an adjacent nested planter 10.

Further, in the embodiment with a basin 70, the body sidewall 50 may include an access port 120. As access port 120 is a localized convex portion of the body sidewall 50 disposed adjacent to the sidewall lower end 54. The access port 120 creates a gap between the body sidewall 50 and the basin 70 so that water may be added to the basin. At the access port 120, and when two nested planters 10 are nested, the gap between the upper and lower nesting planter 10 at the access port 120 may be greater than a small gap, i.e. the nested planters 10 may not have a corresponding shape at the access port 120.

Further, in the embodiment with a basin 70, the sidewall lower end 54 may be offset radially inwardly. This inward offset provides a space whereby the basin sidewall 74 may be substantially aligned with the body sidewall 50. The gap between the basin 70 and the adjacent nesting planter 10 may be greater than a small gap, i.e. the nested planters 10 may not have a corresponding shape at the sidewall lower end 54.

In this configuration, multiple nested planters 10, 10A, 10B may be stacked, i.e. nested, in a minimal space. Because the body sidewalls 50 do not contact each other, there is a reduced chance that the nested planters 10, 10A, 10B will be damaged during shipping and storage. Further, because the body sidewalls 50 do not contact each other the nested planters 10, 10A, 10B are not likely to become stuck together due to friction and/or a partial vacuum forming between the nested planters 10, 10A, 10B.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A nesting planter comprising:
a body having a base assembly and a depending sidewall, said body defining a substantially enclosed space;
said base assembly including a generally horizontal planar member and a stand-off feature;
said stand-off feature structured to extend downwardly from said planar member;
wherein a substantial portion of said body sidewall is structured to correspond to the body sidewall of another nesting planter when two nesting planters are nested.

2. The nesting planter of claim 1 wherein said stand-off feature is structured to be directly coupled to the base assembly of an adjacent nesting planter.

3. The nesting planter of claim 1 wherein said sidewall includes a corresponding portion and a narrowly corresponding portion.

4. The nesting planter of claim 3 wherein said body sidewall narrowly corresponding portion is at an angle of between about 7 and 11 relative to a planar member central vertical axis.

5. The nesting planter of claim 4 wherein said body sidewall narrowly corresponding portion is at an angle of about 9 relative to a planar member central vertical axis.

6. The nesting planter of claim 1 wherein:
said body sidewall includes an upper end and a lower end;
said body sidewall tapers from said upper end to said lower end;
said body sidewall upper end being a flared upper end; and
said body sidewall upper end structured to be disposed immediately adjacent another planter's body sidewall upper end when the other planter is nesting in said body.

7. The nesting planter of claim 1 wherein:
said sidewall includes an upper end and a lower end;
said sidewall tapers from said upper end to said lower end;
said sidewall upper end being a rolled upper end; and
said sidewall upper end structured to be disposed immediately adjacent another planter's body sidewall upper end when the other planter is nesting in said body.

8. The nesting planter of claim 1 wherein said body has no passages therethrough.

9. The nesting planter of claim 1 wherein said stand-off feature includes at least one pedestal.

10. The nesting planter of claim 9 wherein said at least one pedestal is unitary with said base assembly.

11. The nesting planter of claim 9 wherein:
said stand-off feature includes a basin, said basin including a base member and a depending sidewall; and
said basin base member having at least one pedestal coupling component, said base member at least one pedestal coupling component structured to be coupled to said at least one pedestal.

12. The nesting planter of claim 9 wherein:
said at least one pedestal has an upper end and a lower end; and
said at least one pedestal includes a passage extending between said at least one pedestal upper end and said at least one pedestal lower end.

13. A nesting planter comprising:
a body having a base assembly and a depending sidewall, said body defining a substantially enclosed space;
said base assembly including a generally horizontal planar member and a stand-off feature;
said stand-off feature structured to extend downwardly from said planar member;
wherein a substantial portion of said body sidewall is structured to narrowly correspond to the body sidewall of another nesting planter when two nesting planters are nested.

14. The nesting planter of claim 13 wherein said stand-off feature is structured to be directly coupled to the base assembly of an adjacent nesting planter.

15. The nesting planter of claim 13 wherein:
said body sidewall includes an upper end and a lower end;
said body sidewall tapers from said upper end to said lower end;
said body sidewall upper end being a flared upper end; and
said body sidewall upper end structured to be disposed immediately adjacent another planter's body sidewall upper end when the other planter is nesting in said body.

16. The nesting planter of claim 13 wherein:
said sidewall includes an upper end and a lower end;
said sidewall tapers from said upper end to said lower end;
said sidewall upper end being a rolled upper end; and
said sidewall upper end structured to be disposed immediately adjacent another planter's body sidewall upper end when the other planter is nesting in said body.

17. The nesting planter of claim 13 wherein said body has no passages therethrough.

18. The nesting planter of claim 13 wherein said stand-off feature includes at least one pedestal.

19. The nesting planter of claim 18 wherein:
said stand-off feature includes a basin, said basin including a base member and a depending sidewall; and
said basin base member having at least one pedestal coupling component, said base member at least one pedestal coupling component structured to be coupled to said at least one pedestal.

20. The nesting planter of claim 18 wherein:
said at least one pedestal has an upper end and a lower end; and
said at least one pedestal includes a passage extending between said at least one pedestal upper end and said at least one pedestal lower end.
